(19) United States
(12) Patent Application Publication
(10) Pub. No.: US 2013/0024789 A1
(43) Pub. Date: Jan. 24, 2013

(54) Mobile Application For Organizing and Conducting Group Discussions and Activities

(71) Applicants: Habakkuk M. Adkins, Abilene, TX (US); Chris J. Gibbs, Abilene, TX (US); Jonathan Johnson, Abilene, TX (US); James D. Langford, Abilene, TX (US); Chad Q. Martin, San Diego, CA (US); Harvey G. McQueen, Abilene, TX (US)

(72) Inventors: Habakkuk M. Adkins, Abilene, TX (US); Chris J. Gibbs, Abilene, TX (US); Jonathan Johnson, Abilene, TX (US); James D. Langford, Abilene, TX (US); Chad Q. Martin, San Diego, CA (US); Harvey G. McQueen, Abilene, TX (US)

(73) Assignee: Abilene Christian University, Abilene, TX (US)

(21) Appl. No.: 13/553,304

(22) Filed: Jul. 19, 2012

Related U.S. Application Data
(60) Provisional application No. 61/509,198, filed on Jul. 19, 2011.

(51) Int. Cl. G06F 3/048

(52) U.S. Cl. 715/758

(57) ABSTRACT

A mobile application for facilitating the organization and conduction of group discussions and activities. The mobile application comprises a predefined menu having a predefined set of menu options which have data fields for a master user to input the desired parameters. The mobile application sends commands which divide a group into subgroups based on predefined parameters. The mobile application is accessed by participants of subgroups. The mobile application sends topics and prompts, which comprise any sort of input, participation or contribution by the participants of the subgroups desired by the master user. The mobile application provides a reporting menu to a participant of each subgroup for reporting on the subgroup's activities or discussions at the conclusion of a session. The mobile application provides evaluation menus to the participants of the subgroups to allow them to evaluate aspects of the group session, and send the evaluations to the master user.

This is a utility patent application claiming priority to U.S. Provisional Patent Application No. 61/509,198, filed Jul. 19, 2011.

### BACKGROUND OF THE INVENTION

1. Field of the Invention

The present invention relates to mobile applications for IPhones®, PDA's, Blackberries®, and any other smart phone capable of running mobile applications thereon, as well as electronic tablets such as the IPad® or other similar electronic tablets capable of running mobile applications thereon. Specifically, the present invention relates to a mobile application to be used by a plurality of users in a group setting or group settings to accomplish predefined objectives or activities. The mobile application divides a group of people or users into subgroups to facilitate accomplishing the predefined objectives within the subgroups, executes sets of commands to govern or facilitate the subgroups' activities, and allows the users to report to a master module the results of said objectives or activities.

2. Description of the Related Art

A common problem with conducting group discussions, attempting to conduct or accomplish group objectives, or performing other activities in group settings is that the time to accomplish the desired objectives is often limited. The organization or set-up time as well as the time taken to report back to a facilitator often takes up a good deal of the time allotted for the group activity that could otherwise be spent on conducting the group discussions/activities to accomplish the desired objective.

For instance, in a setting such as a classroom, corporate department meeting, or other similar such setting, it may be desirable to divide up the large group into smaller groups to discuss, learn, or otherwise accomplish a desired objective. There are often time limitations imposed on such settings. A typical educational setting provides only one hour to one and a half hours for any particular meeting. Similar time constraints exist in the corporate setting as well.

Attempting to conduct group activities in such settings is often difficult to accomplish due to the time restrictions. By the time the subgroups are organized, various roles are assigned such as reporters, participants, group leaders or facilitators, and the like, and the discussion prompts or objectives are conveyed to the subgroup, there is little time to have meaningful participation among participants of a subgroup to accomplish the desired objectives.

### BRIEF SUMMARY OF THE INVENTION

The present invention provides a mobile application to be used on mobile devices to reduce the amount of organizational time required to create and direct subgroups of people, and provides expedient access to the tasks or objectives of the subgroup, thereby allowing for more time for the participants of the subgroup(s) to participate in the desired activities to accomplish the desired objectives. The preferred embodiment of the present invention comprises a mobile application wherein an IPhone or IPad provides a user interface for each user of the mobile application. However, other mobile devices such as PDA's, Blackberries, or other smart phones capable of running mobile applications, or other electronic tablets capable of running mobile applications can be used to provide the graphical user interface. As used herein, the term “mobile device” is intended to encompass any and all electronic devices capable of loading, storing and/or executing mobile applications thereon.

The mobile application software (not shown) of the present invention is stored on a central server (not shown), and is accessed by a web browser (not shown) of the mobile device, which provides a graphical user interface for the user. The mobile web browser accesses the mobile application software and executes the sets of instructions or commands disclosed herein which are sent by the mobile application software through the central server upon command prompts being executed by the users through the user interface. Any known standard-based mobile web browser, including but not limited to Safari®, Chrome® or other web kit based browser could be used by the mobile device to execute the mobile application software.

The mobile application software comprises a master module (not shown). The master module has a predefined menu loaded thereon. In the preferred embodiment, the master module is accessed and executed only by a master user. Examples of master users include, but are not limited to teachers or professors in a classroom setting, managers of a department or group in a corporate or business setting, or any other individual in a group setting who has the responsibility of organizing a large group into subgroups, disseminating to the subgroups the prompts, tasks, objectives or topics to be discussed or accomplished by the subgroups, and receiving reports of the subgroups' activities or results thereafter.

The master module's predefined menu is accessed by the master user through selection of a “manage” data field displayed on a welcome screen on the master user's mobile device. The master module executes a set of commands (not shown) to display the predefined menu. The predefined menu provides all of the parameters to be set by the master user to create, organize, prompt and facilitate the activities or objectives of the subgroups. The predefined menu includes a “Topics” submenu which provides a data field for the master user to enter a set of data that defines the topic or subject area that governs the subgroups' activities or objectives. The predefined menu also contains a “Prompt” submenu which allows the master user to input in the form of text specific prompts, which represent activities, discussion topics and the like to be performed by the subgroups. The prompts entered by the master user can be the same for each subgroup or can vary from subgroup to subgroup. Moreover, the prompts can vary between participants of a subgroup.

A “Discussion Settings” submenu of the predefined menu provides various parameter fields to allow the master user to divide or subdivide the group into subgroups based on the master user's desire or objectives. For instance, the size of the subgroups can be manually manipulated by the master user. In one embodiment, any particular subgroup can be selected and increased or decreased in number based on the master user's desire. There is a “Roles” submenu within the “Discussion Settings” submenu to allow for the various roles of each subgroup to be assigned. These roles may be assigned manually by the master user, or randomly selected by executing a set of commands (not shown) within the master module. Examples of roles assigned through the master module to participants of a subgroup include, but are not limited to note-takers, reporters, time keepers, leaders, and blog reporters. In one embodiment of the present invention, the master module contains a customizing set of instructions which provides the master user the ability to customize the fields of the predefined menu. In another aspect of the present invention, the master module contains a set of default settings for each field of the predefined menu.

After the predefined menu of the master module has been manipulated by the master user such that all of the desired inputs of the predefined menu are customized to the master user's preference, the master user selects an invitation launch command which executes a set of commands (not shown) in the mobile application software to send an invitation menu to each individual participant of a subgroup. In one embodiment, the invitation menu comprises a session code data field and requires the participants of the subgroup to enter the session code in the data field to join the group. Entering the session code by a participant of a subgroup sends a detection command back to the mobile application software, which sends a counter to the master user's device. In this manner, the master user can detect how many participants have joined. In an alternative embodiment, the detection command can indicate specifically who has joined the session and who has not.

After the participants of a subgroup have joined, the master user sends a subgroup launch command which executes a set of commands (not shown) in the mobile application software to send to each participant of a subgroup an identifier display which tells the participant of a subgroup of which subgroup he or she is a member. Identifier displays can indicate the subgroup by number, color, or any other identifying parameter pre-set by the master user. Once the identifier displays are received by the participants of a subgroup, the subgroups can congregate in predetermined physical areas of a classroom or meeting place to begin the subgroup sessions.

After the subgroups have congregated, the master user selects a role-launch command which executes a set of commands (not shown) in the mobile application software to send each subgroup the roles assigned by the master user. Each participant of a subgroup receives only his or her pre-assigned role.

After executing the subgroup launch command, and the role launch command, the master user then executes a topics and prompts command, which executes a set of commands (not shown) in the mobile application software to send each participant of a subgroup the topic(s) and at least one prompt. The prompts may be the same for each subgroup, and for each participant of a subgroup. The prompts may also be different for each subgroup. Moreover, each participant of a subgroup of a particular subgroup may receive different prompts. The variability of the prompts is set by the master user using the master module to manipulate the predefined menu as desired prior to beginning the session.

The “prompts” of the present invention are a set of input desired to be accomplished by the participants of a subgroup. The prompts could be discussion topics, tasks, activities, or objectives, or any other desired input to be made by the participants of a subgroup. In the preferred embodiment the prompts are be transmitted to each participant of a subgroup. The prompts may be different for each member of a subgroup, or the same for each member of the subgroup. Moreover, the sets of prompts received by each subgroup may be the same or different. In an alternative embodiment, the prompts may be sent only to preselected participants of a subgroup, depending on the selections made in the predefined menu by the master user prior to the session.

After receiving the prompts, the participants of a subgroup participate in the session designed by the master user, and at the pre-designated time. In one embodiment, the participant of a subgroup(s) selected as the reporter enters report data in the form of text on the participant of a subgroup's mobile device, and transmits the same back to the mobile application software, which executes a set of commands (not shown) to send the recording data to the master user. In another embodiment, the reporter reports back to the master user by other means such as orally or in writing.

### DESCRIPTION OF THE DRAWINGS

FIG. 1 is a flowchart showing the overall organization and connection of participants, leaders and the master user to accomplish the group discussions or activities facilitated by the preferred embodiment of the mobile application of the present invention.

FIG. 2 is a flowchart of a session executed by the mobile application of the present invention showing an embodiment of communication through the mobile application of the present invention between participants, leaders and the master user.

FIGS. 3A, 3B and 3C disclose a flowchart showing a set of predefined menus of the mobile application of the present invention for the master user's graphical user interface to create the group activity or discussion to be executed by the mobile application of the present invention.

FIGS. 4A, 4B, 4C and 4D disclose a flowchart showing the preferred embodiment of the mobile application of the present invention.

### DETAILED DESCRIPTION OF THE INVENTION

Referring to the Figures, the mobile application 10 of the present invention comprises a mobile application software (not shown), which is loaded on a central server (not shown). The central server is in communication with a database (not shown) to access and store information related to a group activity to be performed by participants 204 of a subgroup via the mobile application of the present invention. A participant 204 of a subgroup 201 may be the leader 202 of the subgroup 201 or a participant 204 of the subgroup. The participants 204 may be further assigned roles by the role launch command. The mobile application software is accessed by a web browser (not shown) of a mobile device (not shown) of either a master user 200 or a participant 204 of a subgroup. The web browser provides a graphical user interface for the master user 200 as well as the participants 204 of a subgroup. The mobile web browser accesses the mobile application software and executes a given set of instructions thereon through the central server based on the data input by the master user 200 or participants 204 of a subgroup into their respective mobile devices. A given set of instructions or commands are executed upon command prompts being executed by the master user 200 or the participants 204 of a subgroup through the graphical user interface.

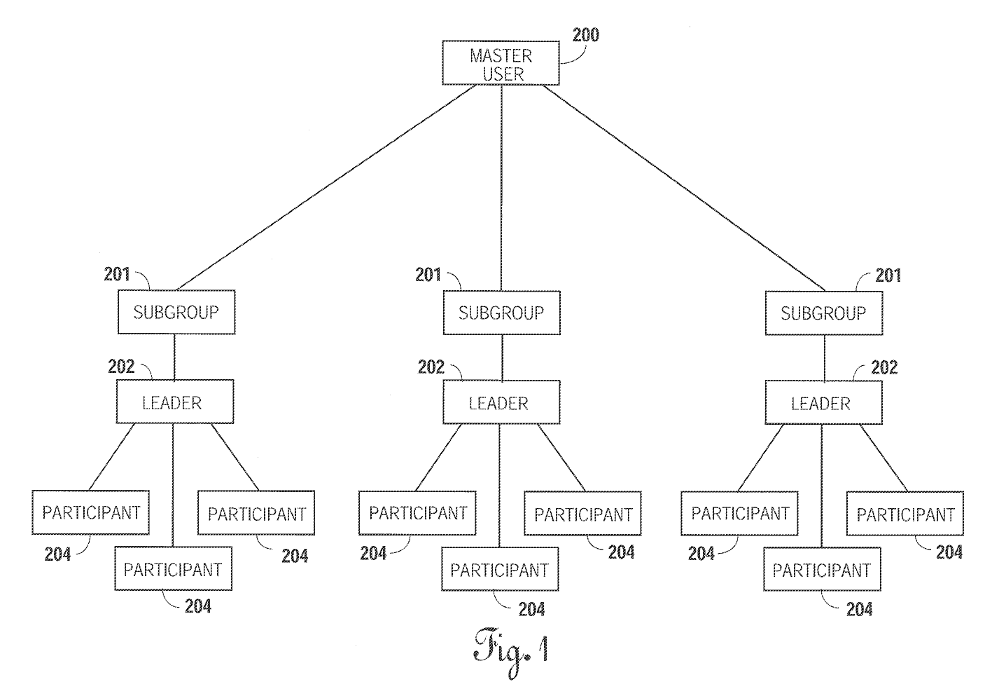

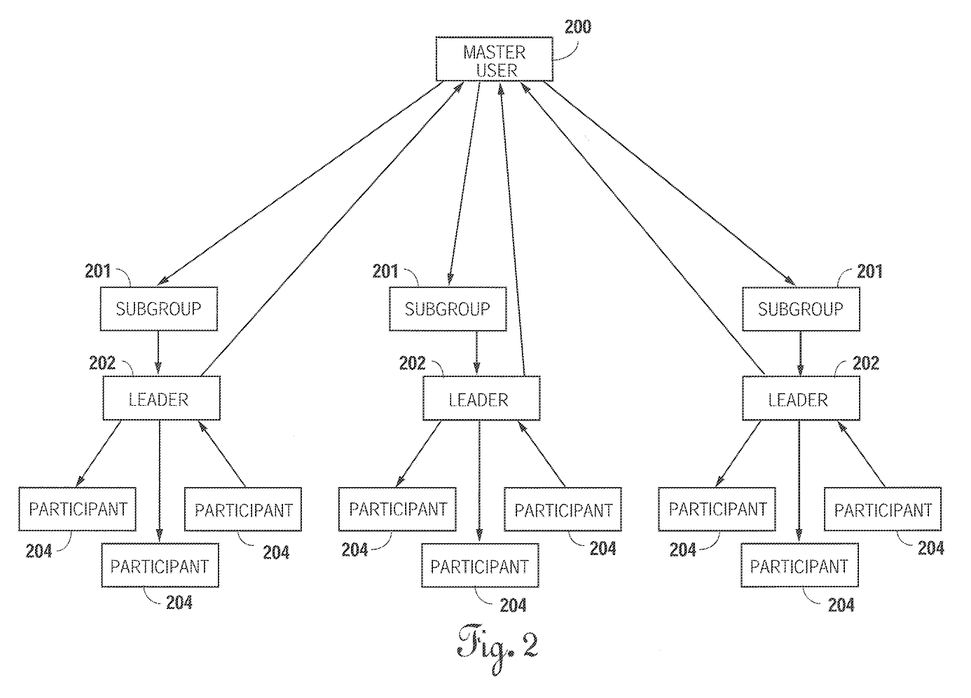

Referring to FIG. 1, the mobile application 10 of the present invention is designed to be used by master user 200 and the participants 204 and leaders 202 of subgroups 201. In the preferred embodiment, a group is divided into subgroups 201, and the participants 204 of the subgroups 201 have roles assigned to them by a role command (not shown). For instance, one or more participants 204 of the subgroup 201 may be a “leader” 202 to facilitate the activity or discussion. The other participants 204 of the subgroup 201 may simply be those who participate in the group discussion or activity through the mobile application 10. The participants 204 may alternatively be assigned other tasks or positions such as “secretary” or “reporter”. In the preferred embodiment, the roles of the participants 204 of the subgroups 201 are chosen by the master user 200 through the master module, and a role command is sent by the mobile application to the participants 204 to indicate which role each participant is assigned.

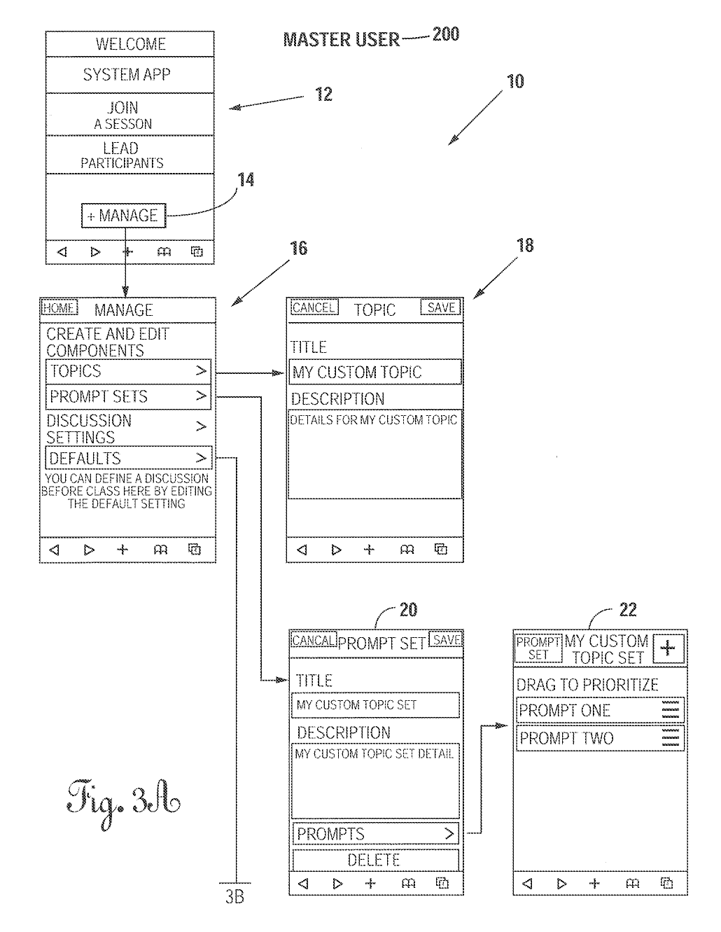

Referring to FIG. 2, the communication paths are indicated by arrows, showing the various communication paths between the master user 200 and the participants 204 of the subgroup 201 through the mobile application 10. As shown, the master user 200 communicates with the participants 204 of the subgroups 201. In one embodiment, this communication is directly between the master user 200 and the leader 202. However, communication between the master user 200 and any one or more of the participants 204 is possible as well. For instance, in one embodiment, the communication through the mobile application 10 may be between the master user 200 and a participant 204 who is designated as the secretary for the task.

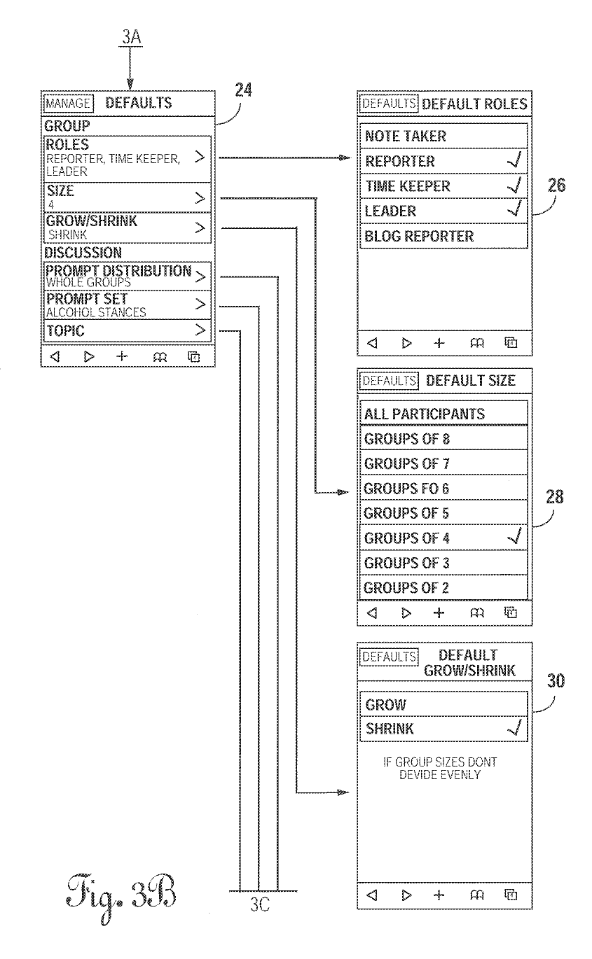

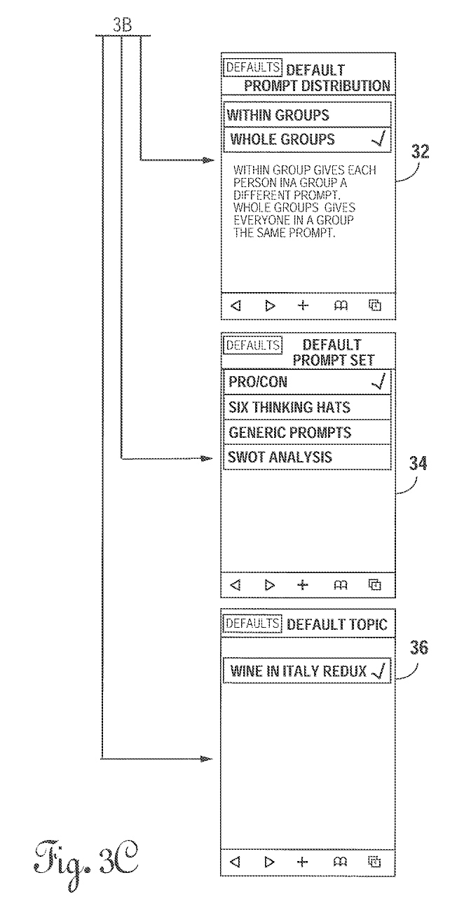

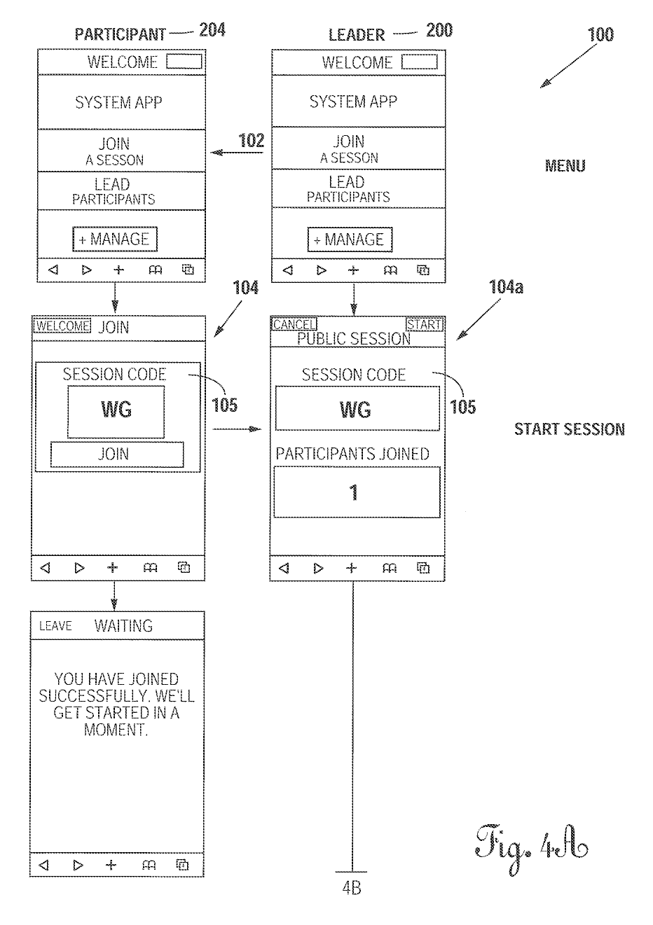

The mobile application software comprises a master module (not shown). Referring to FIGS. 3A, 3B and 3C, the master module has a predefined menu 16 loaded thereon. In the preferred embodiment, the master module is accessed and executed only by the master user 200. The master module preferably provides the master user 200 a set of menu options on the predefined menu 16 to execute a series of sets of commands (not shown) to allow for the organization of a large group into subgroups 201, the dissemination to the subgroups 201 the prompts, tasks, or topics to be discussed or accomplished by the subgroups 201, and the reception of reports of the subgroups' 201 activities or results thereafter, including subsequent transmission of the same to the master user 200. Moreover, the master module allows the master user 200 to imbed external media such as images (not shown), jpegs (not shown), video clips (not shown), maps (not shown), sounds (not shown), or any combination thereof into the various topics, prompts, or roles. Images, jpegs, video clips, maps and/or sound may also be imbedded by participants 204 of the subgroup 201 during the reporting or evaluation stages of a session using the mobile application 10 of the present invention.

Referring to FIG. 3A, the master module's predefined menu 16 is accessed by the master user 200 through selection of a “manage” data field 14 on a welcome display 12. The master module then executes a set of commands (not shown) to display the predefined menu 16. In the preferred embodiment, the predefined menu 16 comprises a “Topics” menu option, a “Prompt Sets” menu option and a “Discussion Settings” menu option. However, different or additional menu options may be provided in the predefined menu 16.

The predefined menu 16 provides all of the parameters to be set by the master user 200 to organize, prompt and facilitate the activities or objectives of the subgroups 201. Selection of the “Topics” menu option by the master user 200 through the user interface causes the mobile application software to execute a set of commands (not shown) to display a topics submenu 18 on the master user's 200 mobile device, which provides a data field for the master user 200 to enter a set of data in the form of text that defines the topic or subject area that governs the subgroups' 201 activities or objectives. Selection of the “Prompt Sets” menu option by the master user 200 through the user interface causes the mobile application software to execute a set of commands (not shown) to display a prompt sets submenu 20. The prompt sets submenu 20 provides a data field for the master user to enter text indicating the title and description of a particular prompt. The prompt sets submenu 20 further provides a prompts submenu 22. The prompt submenu 22 provides a data field to allow the master user to input in the form of text specific prompts, which represent activities, discussion topics, objectives and the like to be performed by the subgroups 201.

Turning to FIGS. 3A and 3B, selection of the “Discussion Settings” menu option by the master user 200 from the predefined menu 16 causes the mobile application software to execute a set of commands (not shown) to display a discussion settings submenu 24 (FIG. 3B), which contains a plurality of discussion setting parameters to be selected by master user 200. For instance, selection in the discussion settings submenu 24 of the “Size” option causes the mobile application software to execute a set of commands (not shown) to display submenu 28, which allows the master user 200 to define the number of individuals for each subgroup 201. Selecting the “Grow/Shrink” option on the discussion settings submenu 24 causes the mobile application software to execute a set of commands (not shown) to display submenu 30, which allows for the master user 200 to manually manipulate the size of the subgroups 201. Selection of the “Roles” option within the discussion settings submenu 24 causes the mobile application software to execute a set of commands (not shown) to display submenu 26, to allow for the various roles of each participants 204 of a subgroup 201 to be assigned by the master user 200. These roles may be assigned manually by the master user 200, or, in an alternative embodiment, randomly selected by the master module. Another option of the mobile application 10 of the present invention is for the mobile application software to randomly assign the roles to the participants 204 of the subgroup 201.

Referring to FIGS. 3B and 3C, selection of the “Prompt Distribution” option from the discussion settings submenu 24 causes the mobile application software to execute a set of commands (not shown) to display a prompt distribution submenu 32. Prompt distribution submenu 32 gives the master user 200 various options as to whether or how to distribute the prompts created from the prompt set menu 20 to the participants 204 of the subgroup 201. Finally, as shown in FIG. 3C, other menu options 34 and 36 are disclosed. As shown, menu options 34 and 36 are default prompt sets and default topics menus, respectively. However, it should be understood that these are only examples of submenus from the predefined menu. Other submenus setting forth different parameters and options may be customized into the master module without departing from the scope and disclosure of the present invention.

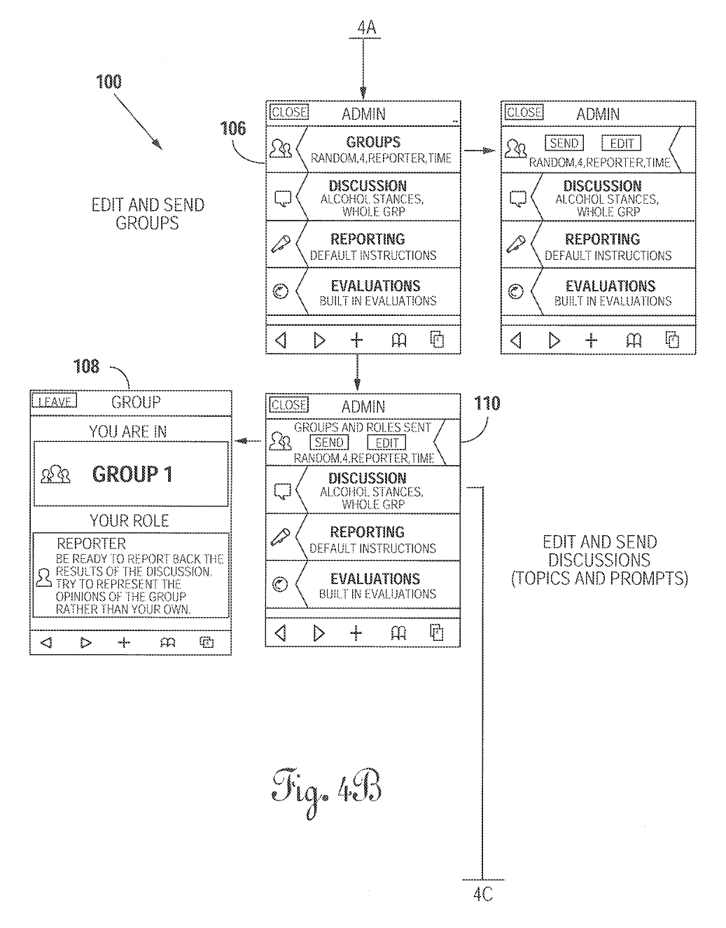

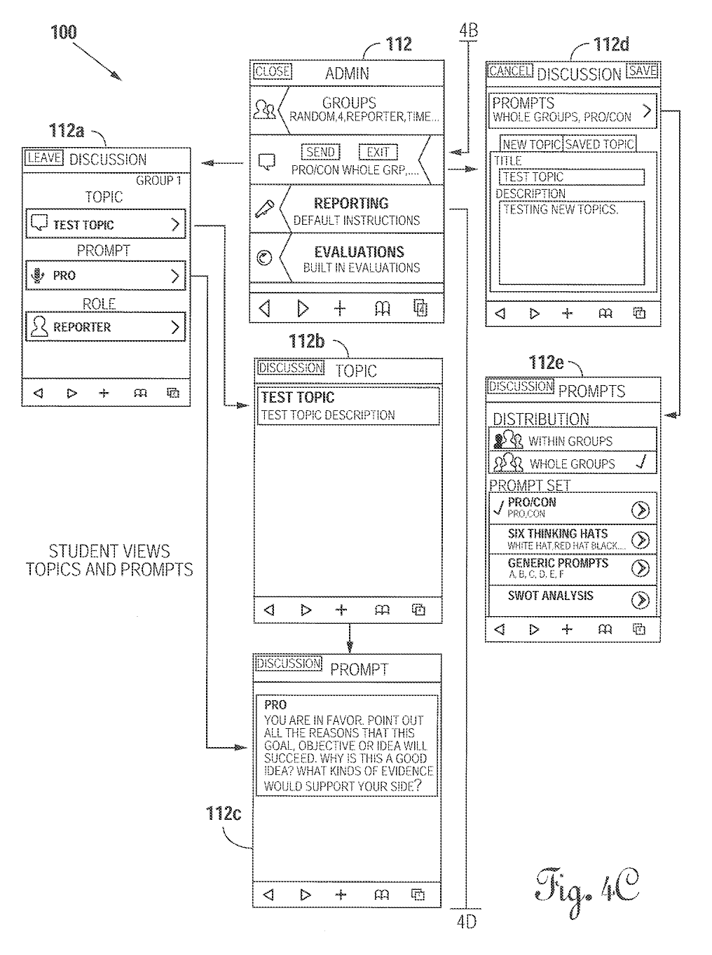

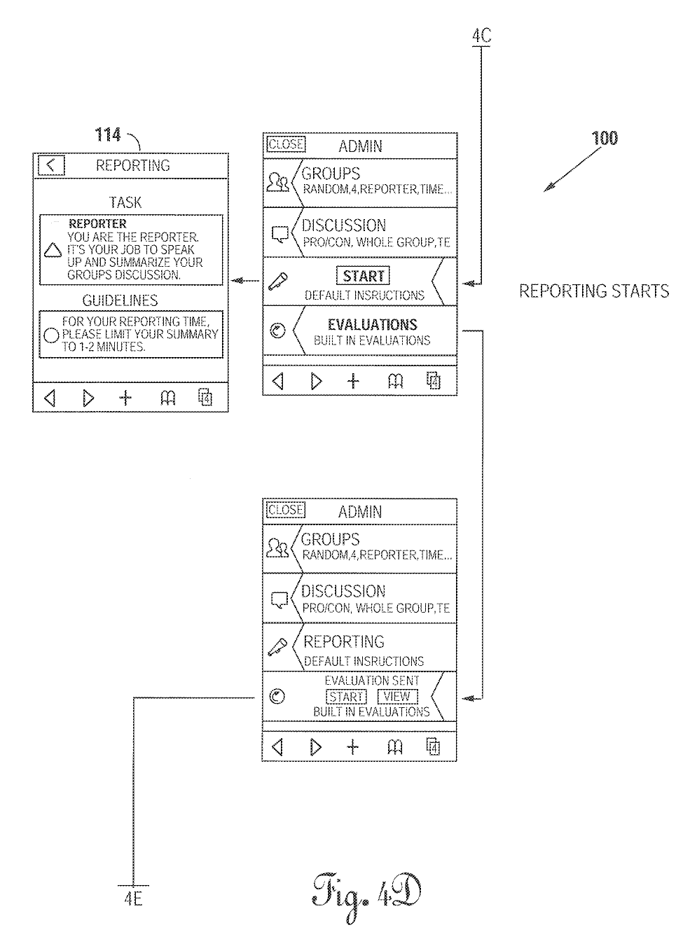

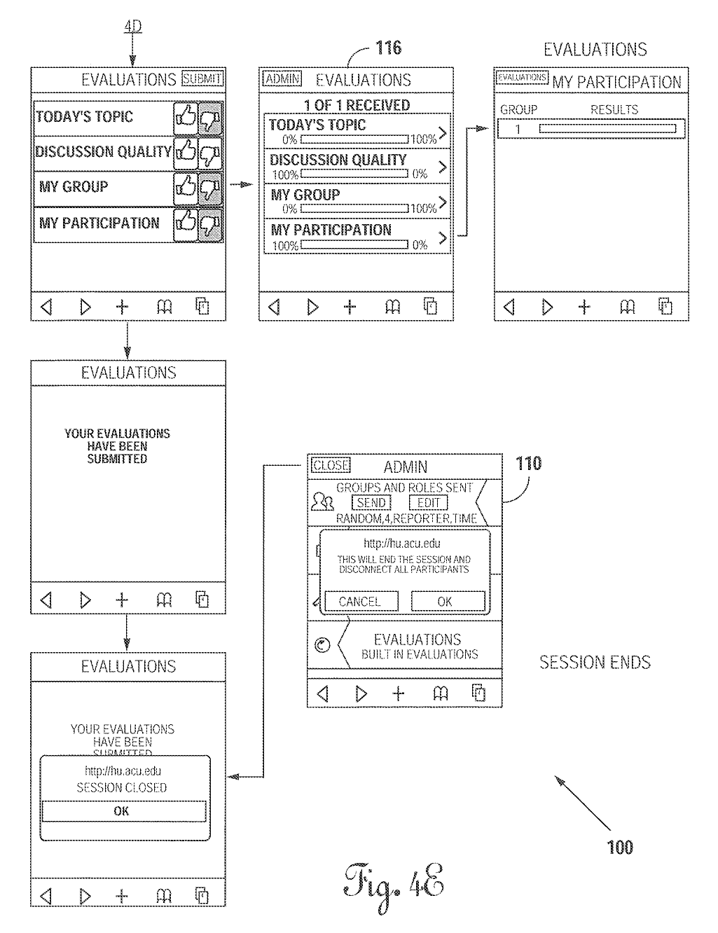

Referring to FIGS. 4A through 4E, after the predefined menu 16 has been manipulated by the master user 200 such that all of the desired inputs of the predefined menu 16 are customized to the master user's 200 preference, the master user 200 begins a subgroup session 100. The subgroup session 100 is executed by a session module (not shown) of the mobile application software after the master user 200 completes his or her graphical user interface with the master module as described hereinabove when desired by master user 200. Referring to FIG. 4A, the master user 200 begins session 100 by selecting an invitation launch command 102 which executes a set of commands (not shown) in the mobile application software to send an invitation menu 104 to each individual of each subgroup 201. In one embodiment, the invitation menu 104 comprises a session code 105 and a data field to manually enter the session code 105 to join a subgroup 201. Entering the session code 105 by a participants 204 of a subgroup 201 sends a detection command back to the mobile application software, which sends a counter 104a to the master user's 200 mobile device. In this manner, the master user 200 can detect how many participants 204 of the subgroups 201 have joined the session 100.

Referring to FIG. 4A and FIG. 4B, after the participants 204 of the subgroups 201 have joined the session 100, the master user 200 sends a subgroup launch command 106 which executes a set of commands (not shown) in the mobile application software to send to each participants 204 of the subgroups 201 identifier displays 108 which tells each participants 204 of each subgroup 201 of which subgroup 201 he or she is a member. Identifier displays 108 can indicate the subgroup 201 by number, color, or any other identifying parameter pre-set by the master user 200, or by default by the mobile application software. Once the identifier displays 108 are received by the participants 204 of the subgroup 201, the subgroups 201 can congregate in predetermined physical areas of a classroom or meeting place to begin the sessions 100.

Referring to FIG. 4B and FIG. 4C, after the subgroups 201 have congregated, the master user 200 selects a role-launch command 110 which executes a set of commands (not shown) in the mobile application software to send each subgroup 201 the roles assigned by the master user 200 or by the mobile application software. Each participants 204 of a subgroup 201 receives only his or her role, as assigned by the master user 200 from the predefined menu 16, or by default by the mobile application software.

After executing the subgroup launch command 106, the master user 200 then executes a topics and prompts command 112 (FIG. 4C), which executes a set of commands (not shown) in the mobile application software to send each participants 204 of the subgroups 201 the topic(s) and associated prompt(s), as shown by references 112a-112e. The prompts and topics 112a-112e may be the same for each subgroup 201, and for each participants 204 of the subgroup 201. The prompts and topics 112a-112e may also be different for each subgroup 201, or different for each participants 204 of a subgroup 201. The variability of the prompts and topics 112a-112e is set by the master user 200 using the master module to manipulate the predefined menu 16 as desired prior to beginning the session 100.

Referring to FIG. 4C and FIG. 4D, after receiving the topics and prompts 112a-112e, the participants 204 of the subgroup 201 participate in the session designed by the master user 200, usually through discussion. In one embodiment, when the discussion is complete, or at any other time desired or selected by the subgroup 201 or the master user 200, the participants 204 of the subgroup 201 selected as the reporter, or any other designated participant 204 or leader 202 of a subgroup 201 enters report data as shown in reference 114 on the his or her mobile device. Once complete, the report data 114 is transmitted back to the mobile application software, which executes a set of commands (not shown) to send the recording data to the master user 200 and store in the mobile application database.

Referring to FIG. 4D and FIG. 4E, at the conclusion of session 100, the mobile application software executes a set of commands (not shown) to display various evaluation options 116 to allow the participants 204 of the subgroups 201 to evaluate various aspects of the subgroup's 201 activity or discussion. The evaluation options 116 are generally a default set of parameters set by the master user 200, but can be customizable to the particular task or discussion as well. After the evaluations are received from the participants 204 of the subgroup 201, the mobile application executes a set of termination commands to send “end of session” signals (not shown) to the participants 204 of the subgroup 201 and the master user 200.

Although the invention has been described with reference to specific embodiments, this description is not meant to be construed in a limited sense. Various modifications of the disclosed embodiments, as well as alternative embodiments of the invention will become apparent to persons skilled in the art upon the reference to the description of the invention. It is therefore contemplated that the appended claims will cover such modifications that fall within the scope of the invention.

We claim:

1. A mobile application for organizing and conducting group discussions and activities, said mobile application comprising:
a mobile application software stored on a server, said mobile application software comprising executable source code;
a plurality of mobile devices in communication with said server and having said mobile application loaded thereon to execute said source code, said plurality of mobile devices corresponding to said members of said group;
a master module of said mobile application software providing a graphical user interface for a master user, said master module comprising a predefined menu with a set of parameters to be defined by said master user;
wherein said parameters of said predefined menu comprise a topics submenu and a prompt set submenu;
said topics submenu being customized by said master user through said graphical user interface with said master module to provide a topic for said interaction among said members of said group;
said prompt set submenu being customized by said master user through said graphical user interface with said master module to provide prompts for said members of said group; and
a session module of said mobile application software for executing a session for said interaction of said group members after said parameters of said predefined menu are defined by said master user, said session module providing a graphical user interface for said participants.

2. The mobile application as disclosed in claim 1 wherein said set of parameters of said predefined menu further comprises a size submenu for said master user to create subgroups from said group and customize sizes of said subgroups.

3. The mobile application as disclosed in claim 2 wherein said subgroups comprise more than one participant, and said set of parameters of said predefined menu further comprises a roles submenu for said master user to customize roles of said participants, said roles submenu comprising the roles of note taker, reporter, time keeper, leader and blog reporter.

4. The mobile application as disclosed in claim 3 wherein said session module comprises a welcome menu comprising a join session and lead session submenu for said participants to select to begin said session.

5. The mobile application as disclosed in claim 4 wherein said session module divides said group into said subgroups and displays a subgroup identifier to said participants on said mobile devices through said mobile application.

6. The mobile application as disclosed in claim 5 wherein said session module displays said roles from said roles submenu to said participants on said mobile devices through said mobile application.

7. The mobile application as disclosed in claim 6 wherein said session module transmits at least one topic from said topics submenu of said master module to said participants on said mobile devices through said mobile application.

8. The mobile application as disclosed in claim 7 wherein said session module transmits at least one prompt from said prompt set submenu of said master module to said participants on said mobile devices through said mobile application, said at least one prompt comprising an objective, task, discussion topic or activity.

9. The mobile application disclosed in claim 8 wherein said session module comprises at least one data field to be displayed on said mobile devices of said participants for at least one of said participants to enter data, said data corresponding to said at least one prompt, said data being transmitted by said mobile application to said master user's mobile device.
